(19) United States
(12) Patent Application Publication
(10) Pub. No.: US 2024/0246373 A1
(43) Pub. Date: Jul. 25, 2024

(54) SYSTEM AND METHOD FOR REAL-TIME ESTIMATION OF TIRE ROLLING RESISTANCE FORCE

(71) Applicant: Bridgestone Americas Tire Operations, LLC, Nashville, TN (US)

(72) Inventor: Thomas A. Sams, Akron, OH (US)

(21) Appl. No.: 18/290,540

(22) PCT Filed: Jun. 24, 2022
(86) PCT No.: PCT/US2022/073131

§ 371 Date: Nov. 14, 2023

Related U.S. Application Data
(60) Provisional application No. 63/237,659, filed on Aug. 27, 2021.

(51) Int. Cl. B60C 23/04; B60C 11/24

(52) U.S. Cl. CPC B60C 23/0484; B60C 11/246; B60C 23/0476

(57) ABSTRACT

Systems (100) and methods (300) are disclosed herein for estimating, e.g., a rolling resistance force (242) acting upon a vehicle-mounted tire. An inventive model implements real-time signals (230) representative of sensed values for tire inflation pressure and/or contained air temperature, and selectively retrieved tire-specific steady state values (224), at least one of which corresponds to a wear state of the tire (222). Since the inflation pressure can be used instead of contained air temperature, the real time signals can be obtained from sensors (118) mounted on an inner liner of the tire, a sensor mounted on a valve of the tire, or even an external sensor wherein the inflation is indirectly obtained. The steady state values may initially be obtained using drum testing or finite element analysis, wherein current wear estimations (250) may further be provided in real time for adjustment of initial values (252) to improve model performance.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF THE DISCLOSURE

The present disclosure relates generally to quantifying performance aspects of tires on wheeled motor vehicles. More particularly, systems, methods, and related algorithms as disclosed herein relate to the estimation of rolling resistance forces acting upon tires of wheeled motor vehicles including but not limited to motorcycles, consumer vehicles (e.g., passenger and light truck), commercial and off-road (OTR) vehicles, based on a sensed tire inflation pressure and/or contained air temperature.

### BACKGROUND

The tire rolling resistance plays a major role in the fuel economy of gas vehicles and the range of elective vehicles. Rolling resistance is often simplified to a single coefficient, the rolling resistance coefficient (or RRC), which when multiplied by the vertical load acting on the tire returns the rolling resistance drag force. There are several issues with this approach. First of all, the RRC varies along with a number of parameters including speed, contained air temperature, tire inflation pressure, tread depth, and the like. In addition, the vertical load acting upon the tire is logistically difficult and/or computationally inefficient to ascertain in real time.

### BRIEF SUMMARY

In view of the aforementioned deficiencies in conventional systems, approaches as disclosed herein for more efficiently determining the rolling resistance force acting on a tire may be implemented to further provide important performance-related feedback. The rolling resistance may be estimated by utilizing either a contained air temperature or contained air pressure measurement, without requiring other complex variables. This rolling resistance estimate can then be used in one or more of the following ways, such as for example to provide a more accurate estimate regarding fuel economy and/or range for a given tire-vehicle combination. Feedback according to the present disclosure may provide vehicle fleets with a better understanding of expected fuel costs. When changing tire designs, feedback according to the present disclosure may provide fleet management entities and/or individual vehicle owners with accurate estimates of fuel savings or battery range corresponding to their specific driving behavior.

An exemplary embodiment of a method as disclosed herein may be provided for estimating at least one force acting upon a tire mounted on a vehicle. The method includes obtaining at least signals representative of sensed values for tire inflation pressure and/or contained air temperature, and retrieving from data storage one or more tire-specific steady state values, at least one of the one or more tire-specific steady state values corresponding to at least a wear state of the tire. A rolling resistance force acting upon the tire may then be estimated, based on at least the one or more tire-specific steady state values and the sensed values for tire inflation pressure and/or contained air temperature. Output signals may then be generated corresponding to the estimated rolling resistance force acting on the tire.

In one exemplary aspect according to the above-referenced embodiment, the signals representative of sensed values for tire inflation pressure and/or contained air temperature may be obtained via at least one sensor mounted to an inner liner of the tire, e.g., a tire pressure monitoring system (TPMS) sensor.

A current wear state of the tire may be estimated in real time based on obtained signals, via the at least one sensor mounted to the inner liner of the tire, corresponding to dynamic mechanical behavior of the tire. The at least one tire-specific steady-state value corresponding to at least the wear state of the tire may further be updated based on the estimated current wear state.

In another exemplary aspect according to the above-referenced method, signals representative of sensed values for tire inflation pressure may be obtained via a sensor mounted to a valve of the tire.

In another exemplary aspect according to the above-referenced method, signals representative of sensed values for tire inflation pressure are obtained indirectly via a wheel speed sensor external to the tire.

In another exemplary aspect according to the above-referenced method, a current wear state of the tire may be estimated in an event-driven manner based on obtained signals, via at least one external sensor proximate the tire, corresponding to at least a tread depth of the tire, wherein the at least one tire-specific steady-state value corresponding to at least the wear state of the tire may be updated based on the estimated current wear state.

In another exemplary aspect according to the above-referenced method, a current wear state of the tire may be estimated in real time based at least in part on a determined location in which the tire is mounted on the vehicle, wherein the at least one tire-specific steady-state value corresponding to at least the wear state of the tire may be updated based on the estimated current wear state. The rolling resistance force acting upon the tire may accordingly be estimated based on at least the one or more tire-specific steady state values and/or the sensed values and/or the determined location in which the tire is mounted on the vehicle.

In another exemplary aspect according to the above-referenced method, a predictive model may be selected relating to energy consumption for the tire and/or the vehicle and/or an operator of the vehicle. Energy consumption values are predicted based on at least the output signal corresponding to the estimated rolling resistance force acting on the tire as an input to the selected predictive model, and a display output is generated corresponding to the predicted energy consumption values to an onboard user interface and/or a user interface associated with a fleet management telematics platform.

The predicted energy consumption values may for example comprise a predicted fuel economy and/or a predicted driving range.

In another exemplary aspect according to the above-referenced method, historical data are selectively retrieved from data storage relating to driving behavior for the tire and/or the vehicle and/or an operator of the vehicle. One or more of the energy consumption values are accordingly predicted further based on the selectively retrieved historical data as an input to the selected predictive model.

In another exemplary aspect according to the above-referenced method, the predicted one or more of the energy consumption values comprises an estimated fuel savings upon changing to a respective alternative tire and/or an estimated driving range upon changing to the respective alternative tire.

In another exemplary aspect according to the above-referenced method, tire data are selectively retrieved from data storage relating to a type of the tire mounted on the vehicle and one or more alternative types of tires. Relative energy consumption values may accordingly be predicted for each of the type of the tire mounted on the vehicle and the one or more alternative types of tires.

In another exemplary aspect according to the above-referenced method, the estimated current tire wear may be further utilized as an input to a tire traction detection model.

In another exemplary aspect according to the above-referenced method, the estimated current tire wear and/or an estimated tire traction based at least in part on the estimated tire wear may be provided as an input to a vehicle control unit, such as for example an active safety unit.

In another embodiment as disclosed herein, a system is provided for estimating at least one force acting upon a tire mounted on a vehicle, including at least one sensor configured to generate signals representative of values for inflation pressure of the tire and/or contained air temperature of the tire, and data storage having entered and stored thereon one or more tire-specific steady state values, at least one of the one or more tire-specific steady state values corresponding to at least a wear state of the tire. A computing device is in communication with the at least one sensor and the data storage and further configured to direct the performance of steps in a method according to the above-referenced embodiment and optionally any one or more of the associated exemplary aspects.

The computing device may for example be an onboard computing device with respect to the vehicle, a mobile computing device with respect to an operator of the vehicle, a remote server network communicatively linked to the various system components, part of a fleet management telematics platform, or the like.

In another embodiment as disclosed herein, a computer program product may include a non-transitory computer readable medium having program instructions residing thereon and executable by a processor to direct the performance of steps in a method according to the above-referenced embodiment and optionally any one or more of the associated exemplary aspects. Such a computer program product may for example and without limitation be embodied in an onboard computing device with respect to the vehicle, a mobile computing device with respect to an operator of the vehicle, a remote server network communicatively linked to the various system components, part of a fleet management telematics platform, or the like.

### BRIEF DESCRIPTION OF THE SEVERAL VIEWS OF THE DRAWINGS

Hereinafter, embodiments of the invention are illustrated in more detail with reference to the drawings.

FIG. 1 is a block diagram representing an embodiment of a tire rolling resistance estimation system as disclosed herein.

FIG. 2 is a flowchart representing an embodiment of a tire rolling resistance estimation method as disclosed herein.

### DETAILED DESCRIPTION

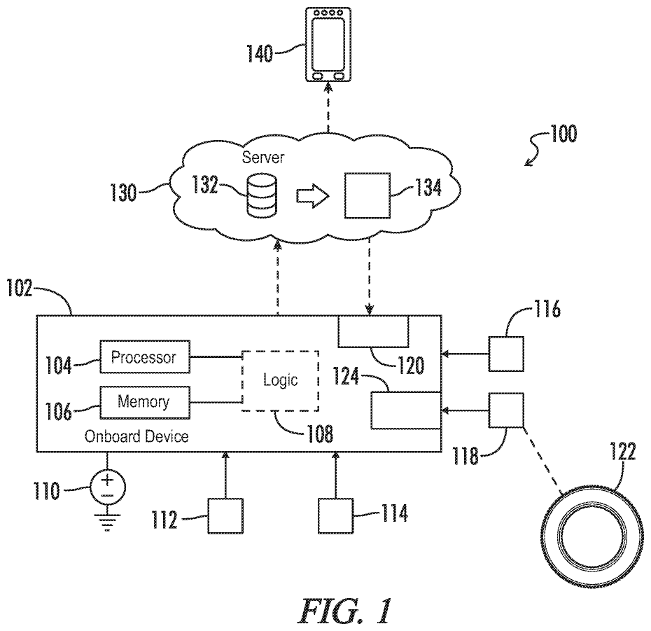

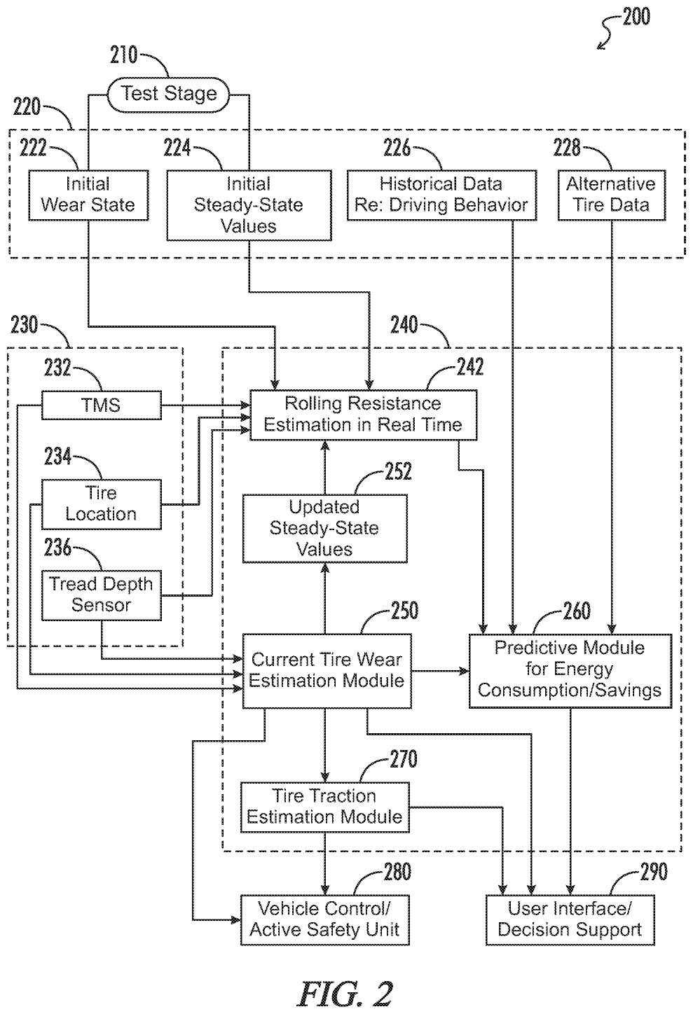

Referring generally to FIGS. 1-2, various exemplary embodiments of an invention may now be described in detail. Where the various figures may describe embodiments sharing various common elements and features with other embodiments, similar elements and features are given the same reference numerals and redundant description thereof may be omitted below. A system 100 according to certain embodiments may include, and/or a method 200 according to certain embodiments may be executed by, a computing device 102 that is local and for example resides in association with a vehicle, or a computing device 130, 140 that is remote and for example is part of a cloud-based network or a fleet management system, or some combination thereof within the scope of the present disclosure. Centralized or distributed data processing may accordingly be implemented based on inputs from specified sensors, or to at least initiate the generation of output signals are further described herein to specified interfaces, control systems, or actuators, without limitation unless otherwise specifically stated.

Referring initially to FIG. 1, one exemplary embodiment of a system 100 as disclosed herein includes a data acquisition device 102 that is onboard a vehicle and configured to perform relevant computations as disclosed herein, and/or to at least obtain data and transmit said data to one or more downstream computing devices (e.g., a remote server 130) to perform relevant computations as disclosed herein. The data acquisition device may be a standalone sensor unit (not shown) appropriately configured to collect raw measurement signals, such as for example signals corresponding to a tire's radial acceleration, contained air temperature, and/or internal inflation pressure, and to continuously or selectively transmit such signals to downstream computing devices. The data acquisition device 102 may comprise an onboard computing device 102 in communication with one or more distributed sensors and which is portable or otherwise modular as part of a distributed vehicle data collection and control system, or otherwise may be integrally provided with respect to a central vehicle data collection control system. The data acquisition device 102 may include a processor 104 and memory 106 having program logic 108 residing thereon, and in various embodiments may comprise a vehicle electronic control unit (ECU) or a component thereof, or otherwise may be discrete in nature, for example permanently or detachably provided with respect to a vehicle mount.

Generally stated, a system 100 as disclosed herein may implement numerous components distributed across one or more vehicles, for example but not necessarily associated with a fleet management entity, and further a central server network or event-driven serverless platform in functional communication with each of the vehicles motor via a communications network.

The illustrated embodiment may include for illustrative purposes, without otherwise limiting the scope of the present invention thereby, a tire-mounted sensor unit 118, an ambient temperature sensor 112, a vehicle speed sensor 114 configured to collect for example acceleration data associated with the vehicle, position sensors 116 such as global positioning system (GPS) transponders, and a DC power source 110. The tire mounted sensor unit 118 may include one or more sensors mounted to an inner liner of the tire, to a valve of the tire, or the like, and configured to generate output signals corresponding to tire conditions including any or all of radial acceleration, contained air temperature, inflation pressure, and the like, and such sensors may take any of various forms known to one of skill in the art for providing such signals. Various bus interfaces, protocols, and associated networks are well known in the art for the communication between the respective data sources and the local computing device 102 and/or servers 130, including for example an onboard receiver 124, and one of skill in the art would recognize a wide range of such tools and means for implementing the same.

In some embodiments, data acquisition devices and equivalent data sources as disclosed herein are not necessarily limited to vehicle-specific sensors and/or gateway devices and can also include third party entities and associated networks, program applications resident on a user computing device such as a driver interface, a fleet management interface, and any enterprise devices or other providers of raw streams of logged data as may be considered relevant for algorithms and models as disclosed herein.

In some embodiments, one or more of the various sensors 112, 114, 116, 118 may be configured to communicate with downstream platforms without a local vehicle-mounted device or gateway components, such as for example via cellular communication networks or via a mobile computing device (not shown) carried by a user of the vehicle.

The term “user interface” as used herein may, unless otherwise stated, include any input-output module by which a user device facilitates user interaction with respect to a processing unit, server, device, or the like as disclosed herein including, but not limited to: downloaded or otherwise resident program applications; web browsers; web portals, such as individual web pages or those collectively defining a hosted website; and the like. A user interface may further be described with respect to a personal mobile computing device in the context of buttons and display portions which may be independently arranged or otherwise interrelated with respect to, for example, a touch screen, and may further include audio and/or visual input/output functionality even without explicit user interactivity.

Vehicle and tire sensors 112, 114, 116, 118, etc., may in an embodiment further be provided with unique identifiers, wherein an onboard device processor can distinguish between signals provided from respective sensors on the same vehicle, and further in certain embodiments wherein a central processing unit and/or fleet maintenance supervisor client device may distinguish between signals provided from tires and associated vehicle and/or tire sensors across a plurality of vehicles. In other words, sensor output values may in various embodiments be associated with a particular tire, a particular vehicle, and/or a particular tire-vehicle system for the purposes of onboard or remote/downstream data storage and implementation for calculations as disclosed herein. An onboard data acquisition device 102 may communicate directly with the downstream processing stage 130 as shown in FIG. 1, or alternatively the driver's mobile device or truck-mounted computing device may be configured to receive and process/transmit onboard device output data to one or more downstream processing units.

Raw signals received from a tire-mounted sensor 118, whether mounted to an inner liner of the tire or a valve of the tire or the like, may optionally be stored in onboard device memory 106, or an equivalent local data storage network functionally linked to the onboard device processor 104, for selective retrieval and transmittal via a data pipeline stage as needed for calculations according to the method disclosed herein. A local or downstream “data storage network” as used herein may refer generally to individual, centralized, or distributed logical and/or physical entities configured to store data and enable selective retrieval of data therefrom, and may include for example but without limitation a memory, look-up tables, files, registers, databases, database services, and the like. In some embodiments, raw data signals from the various sensors 112, 114, 116, 118 may be communicated substantially in real time from the vehicle to a downstream processing unit such as server 132. Alternatively, particularly in view of the inherent inefficiencies in continuous data transmission of high frequency data, the data may for example be compiled, encoded, and/or summarized for more efficient (e.g., periodic time-based or alternatively defined event-based) transmission from the sensors or an onboard device (i.e., associated with the vehicle) to a remote processing unit via an appropriate (e.g., cellular) communications network.

The vehicle data and/or tire data, once transmitted via a communications network to a downstream server 132 or equivalent processing system, may be stored for example in a database 134 associated therewith and further processed or otherwise retrievable as inputs for processing via one or more algorithmic models as disclosed herein. The models may be implemented at least in part via execution of a processor, enabling selective retrieval of the vehicle data and/or tire data and further in electronic communication for the input of any additional data or algorithms from a database, lookup table, or the like that is stored in association with the processing unit.

With further referring hereafter to FIG. 2, an embodiment of a method 200 as disclosed herein may be implemented for estimating a rolling resistance acting on a tire by utilizing real time signals corresponding to a contained air temperature and/or contained air pressure measurement associated with the tire.

In an embodiment, a testing stage 210 is implemented as a first or preliminary step to the method 200, whereby at least initial values for a tire wear state 222 and steady-state variables 224 specific to the tire and/or type of tire may be identified. The initial values may be retrievably stored in data storage 220 such as for example in the context of selectable models based on real-time values as described further herein. The steady-state variables 224 may include one or more variables for which the associated values are dependent at least in part on the tire wear status, also as further described herein.

The testing stage 210 may take any of various forms without limitation unless otherwise stated herein, and may include for example physical testing of a specific or representative tire on for example a drum in a manner as known in the art, and may further or alternatively include simulated testing such as for example using finite element analysis, or the like.

An exemplary embodiment of a process for determining the relevant steady-state values may be described as follows. One of skill in the art may generally acknowledge three main causes for tire rolling resistance, i.e., energy loss due to cyclic deformation of rubber/reinforcements in the tire, frictional energy in the footprint (also referred to as a contact patch), and aerodynamic drag of the tire. The first of these three causes, material energy loss, may be described as having the largest impact overall. Since rubber is a viscoelastic material, when it is put under cyclic deformation there is energy loss due to hysteresis. Nearly all this energy loss can be considered dissipated as heat, thus the connection between rolling resistance and temperature.

An energy balance analysis for the tire yields the following equation:

$${\dot{Q}}_{GEN} - {\dot{Q}}_{SURR} = {\dot{Q}}_{STORED}$$

where Q is the rate of heat transfer and the suffixes GEN, SURR, and STORED refer to the rate of heat transfer being generated by the tire, being transferred to the surroundings, and being stored in the tire, respectively. If all the rolling resistance is assumed to be dissipated as heat, then the rate of heat transfer generated by the tire is equal to the rolling resistance force multiplied by the velocity of the vehicle. The previous equation can further be written as

$${F}_{RR} V - hA ( T - {T}_{∞} ) = {mc}_{p} \dot{T}$$

In the above equation, FRR is the rolling resistance force, V is the vehicle speed, h is a heat transfer coefficient of the tire, A is the surface area of the tire, T is the temperature, T_{∞} is the ambient temperature or wheel well temperature, m is the tire mass, and cₚ is the specific heat capacity of the tire.

This differential equation can be solved for the transient temperature, which is

$$T ( t ) = {F}_{RR} V / hA + {T}_{∞} + ( T ( 0 ) - {F}_{RR} V / hA - {T}_{∞} ) {e}^{- {( \frac{hA}{{mc}_{p}} )}^{t}}$$

where T(0) is the initial temperature and t is the time.

The term in the exponential can be determined by, e.g., measuring the tire temperature as it runs continuously on a drum at constantly maintained load, speed, and inflation pressure.

This term is called the time constant, which relates to the terms in the above equation by

$$τ = {mc}_{p} / hA$$

The rolling resistance force can be solved for by rearranging the above equation to

$${F}_{RR} = hA / V [ ( T ( t ) - T ( 0 ) {e}^{- l / τ} ) / ( 1 - {e}^{- l / τ} ) {T}_{∞} ]$$

The term hA is also complex to understand but can be determined as previously noted using finite element analysis, drum testing, or the like. From the transient temperature equation, the steady-state temperature can be found

$${T}_{SS} = {F}_{RR} V / hA + {T}_{∞}$$

So, by measuring or simulating certain tire steady-state conditions, and knowing the respective rolling resistance for that condition, the term hA can be determined.

In view of the preceding discussion, the present embodiment enables rolling resistance force to be accurately estimated (step 242) from a small number of variables which may be easily obtained and implemented in real time, such as for example measurements for contained air temperature, ambient temperature, speed, and the like. Contained air temperature may be easily and reliably obtained for example via input signals 230 from one or more sensing units, including for example inputs 232 from a sensor mounted on the inner liner of the tire. The tire inflation pressure (contained air pressure) is also related to the contained air temperature of the tire by the ideal gas law, and therefore an accurate pressure measurement can be used in place of contained air temperature. This means that other sensors such as valve-mounted tire sensors may be utilized which effectively measure the tire inflation pressure but may not be as reliably implemented for contained air temperature measurements. In addition, external devices may be used such as for example sensors associated with anti-lock braking systems which are configured to generate signals corresponding to wheel speed, and via which the tire inflation pressure may be sufficiently derived to estimate the rolling resistance force generated by the tire. This method can be used to eliminate many of the complex interactions and unknowns when estimating rolling resistance. The speed, load and pressure effect are all captured, as well as the tread depth effect since the tire runs cooler as the tread depth decreases. The contained air temperature acts as a proxy for rolling resistance.

In an embodiment, other input signals 230 may include or otherwise represent a mounted location 234 of the tire on the vehicle may be relevant as an input to the rolling resistance estimation, for example in the context of contextualizing the current inputs for contained air temperature or tire inflation pressure. Sensed values for the tire tread depth 236 or equivalent wear-related values may be provided, via for example external sensors that may be periodically implemented to make a direct measurement and feed such signals to the rolling resistance estimation module.

In a particular exemplary embodiment as disclosed herein, one or more of the input signals 230 including signals corresponding to contained air temperature and/or inflation pressure from a tire-mounted sensor 232, a mounted tire location input 234, a tread depth input 236, and the like may be provided to a current tire wear estimation module 250 wherein a current tire wear status may be estimated and utilized to update 252 certain wear-related ones of the steady-state values that are fed back for rolling resistance estimation (in step 242 or subsequent iterations thereof), including for example an estimated mass, surface area and the like.

In various embodiments, an output signal from the current tire wear estimation module 250 may be provided (step 290) to a user interface associated with the vehicle for local display to a user of the vehicle, and/or a user interface associated with a remote computing device via for example a fleet management telematics platform. An output signal from the current tire wear estimation module 250 may further or in the alternative be provided to a vehicle control unit 280. An output signal from the current tire wear estimation module 250 may be utilized as an input to a tire traction detection model 270, a further output from which may be provided to the vehicle control unit 280 along with or alternatively to the output from the current tire wear estimation module.

In an embodiment, an output signal from the current tire wear estimation module 250 may be provided to a predictive module executed by a computing device (onboard device, server, fleet management system) as disclosed herein, which may for example select or enable selection of an appropriate predictive model relating to energy consumption for the tire and/or the vehicle and/or an operator of the vehicle. Energy consumption values may be predicted for example based on the output from the rolling resistance estimation module 242, and a display output 290 may be generated corresponding to the predicted energy consumption values to an onboard user interface and/or a user interface associated with a fleet management telematics platform. Exemplary predicted energy consumption values may include a predicted fuel economy and/or a predicted driving range. Further exemplary predicted energy consumption values such as an estimated fuel savings upon changing to a respective alternative tire and/or an estimated driving range upon changing to the respective alternative tire may be provided based on the availability of historical data 226 as selectively retrieved from data storage relating to driving behavior for the tire and/or the vehicle and/or an operator of the vehicle. The predictive module 260 may further selectively retrieve information from data storage relating to a type of the tire mounted on the vehicle and one or more alternative types of tires 228. Relative energy consumption values may accordingly be predicted for each of the type of the tire mounted on the vehicle and the one or more alternative types of tires.

In an embodiment, the predictive module 260 may predict a fuel economy, driving range, or the like based on each of a number of characteristic tire inflation pressure values, such as for example in a range upward from a current tire inflation pressure value such that an operator of the vehicle upon which the tire is mounted may receive decision support regarding the at least partial advantages to be gained by further inflating one or more tires on the vehicle. Such decision support information may for example be provided in the form of an explicit recommendation to inflate one or more tires to a defined tire inflation pressure value, or in the form of respective energy consumption values for each of a number of tire inflation values, as estimated using a system and method as disclosed herein. In a particular example wherein an operator of a vehicle may be associated with a predetermined or typical route and a predicted driving range of the vehicle based on current tire inflation values is within a defined tolerance of a distance to be driven in association with said route, the predictive module 260 may initiate alerts to the operator for intervention such as tire inflation.

An exemplary tire wear estimation model may estimate tire wear values based on, e.g., “digital twin” virtual representations of various physical parts, processes or systems wherein digital and physical data is paired and combined with learning systems such as for example neural networks. For example, the above-referenced input signals and associated location/route information may be provided to generate a digital representation of the vehicle tire for estimation of tire wear, wherein subsequent comparison of the estimated tire wear with a determined actual tire wear may be implemented as feedback for the machine learning algorithms. Such a wear model may be implemented at the vehicle, for processing via the onboard system, or the tire data and/or vehicle data may be processed to provide representative data to a hosted server for remote wear estimation.

In various embodiments, the method may further involve predicting wear values at one or more future points in time, wherein such predicted values may be compared to respective threshold values. For example, a feedback signal corresponding to the predicted tire wear status (e.g., predicted tread depth at a given distance, time, or the like) may be provided via an interface to an onboard device associated with the vehicle itself, or to a mobile device associated with a user, such as for example integrating with a user interface configured to provide alerts or notice/recommendations that a tire should or soon will need to be replaced. Other tire-related threshold events can be predicted and implemented for alerts and/or interventions within the scope of the present disclosure and based on predicted tire wear, including for example tire rotation, alignment, inflation, and the like. The system may generate such alerts and/or intervention recommendations based on individual thresholds, groups of thresholds, and/or non-threshold algorithmic comparisons with respect to predetermined parameters.

As another example, a hierarchical wear model may enable fleet management systems to track performance of not only specific vehicles and tires, but associated historical data 226 regarding driving behavior including tire conditions, routes, drivers, and the like. Using predicted wear rates, a fleet manger may for example ascertain which trucks, drivers, routes, and/or tire models are burning through tread the fastest, or conversely, saving tread. Furthermore, accurate wear modeling may preferably provide decision support with respect to fleet tire purchasing. Wear out prediction may for example be aggregated into a projected tire purchase estimation model for a given year, month, week, or the like.

As another example, an autonomous vehicle fleet may comprise numerous vehicles having varying minimum tread status values, wherein the fleet management system may be configured to proactively disable deployment of vehicles falling below a minimum threshold. The fleet management system may further implement varying minimum tread status values corresponding to wheel positions. The system may accordingly be configured to act upon a minimum tire tread value for each of a plurality of tires associated with a vehicle, or in an embodiment may calculate an aggregated tread status for the plurality of tires for comparison against a minimum threshold.

As previously noted, tire wear status (e.g., tread depth) may for example be provided along with the above-referenced output signals as inputs to a traction model 270, which may be configured to provide an estimated traction status or one or more traction characteristics for the respective tire. As with the aforementioned wear model, the traction model may comprise “digital twin” virtual representations of physical parts, processes or systems wherein digital and physical data are paired and combined with learning systems such as for example artificial neural networks. Real vehicle data and/or tire data from a particular tire, vehicle or tire-vehicle system may be provided throughout the life cycle of the respective asset to generate a virtual representation of the vehicle tire for estimation of tire traction, wherein subsequent comparison of the estimated tire traction with a corresponding measured or determined actual tire traction may preferably be implemented as feedback for machine learning algorithms executed at a server level.

The traction model may in various embodiments utilize the results from prior testing, including for example stopping distance testing results, tire traction testing results, etc., as collected with respect to numerous tire-vehicle systems and associated combinations of values for input parameters (e.g., tire tread, inflation pressure, road surface characteristics, vehicle speed and acceleration, slip rate and angle, normal force, braking pressure and load), wherein a tire traction output may be effectively predicted for a given set of current vehicle data and tire data inputs.

In one embodiment, outputs from this traction model may be incorporated into an active safety system 280. The term “active safety systems” as used herein may preferably encompass such systems as are generally known to one of skill in the art, including but not limited to examples such as collision avoidance systems, advanced driver-assistance systems (ADAS), anti-lock braking systems (ABS), etc., which can be configured to utilize the traction model output information to achieve optimal performance. For example, collision avoidance systems are typically configured to take evasive action, such as automatically engaging the brakes of a host vehicle to avoid or mitigate a potential collision with a target vehicle, and enhanced information regarding the traction capabilities of the tires and accordingly the braking capabilities of the tire-vehicle system are eminently desirable.

In another embodiment, a ride-sharing autonomous fleet could use output data from the traction model 270 as decision support feedback 290 to disable or otherwise selectively remove vehicles with low tread depth from use during inclement weather, or potentially to limit their maximum speeds.

In some embodiments, the method 200 may also involve providing inputs such as the estimated forces acting on the tire, the estimated wear, alone or in combination with other relevant metrics of severity of use of the tire, as inputs to a tire durability and health model. Such a model may be implemented for estimating relative fatigue characteristics, for example as an indicator of durability events such as tread/belt separations. Such a model may also for example be implemented for estimating relative tire aging characteristics or predicting wear state at one or more future points in time. Feedback signals corresponding to such durability events may be provided via an interface to an onboard device 102 associated with the vehicle itself, or to a mobile device associated with a user, such as for example integrating with a user interface configured to provide alerts or notice/recommendations of an intervention event, such as for example that one or more tires should or soon will need to be replaced, rotated, aligned, inflated, and the like. Outputs from a tire durability and health model may further or in the alternative be provided to the traction model referenced above.

Throughout the specification and claims, the following terms take at least the meanings explicitly associated herein, unless the context dictates otherwise. The meanings identified below do not necessarily limit the terms, but merely provide illustrative examples for the terms.

The meaning of “a,” “an,” and “the” may include plural references, and the meaning of “in” may include “in” and “on.”

The phrase “in one embodiment,” as used herein does not necessarily refer to the same embodiment, although it may.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Whereas certain preferred embodiments of the present invention may typically be described herein with respect to methods executed by or on behalf of fleet management systems and more particularly for autonomous vehicle fleets or commercial trucking applications, the invention is in no way expressly limited thereto and the term “vehicle” as used herein unless otherwise stated may refer to an automobile, truck, or any equivalent thereof, whether self-propelled or otherwise, as may include one or more tires and therefore require accurate estimation or prediction of tire internal air pressure loss and potential disabling, replacement, or intervention.

The term “user” as used herein unless otherwise stated may refer to a driver, passenger, mechanic, technician, fleet management personnel, or any other person or entity as may be, e.g., associated with a device having a user interface for providing features and steps as disclosed herein.

The previous detailed description has been provided for the purposes of illustration and description. Thus, although there have been described particular embodiments of a new and useful invention, it is not intended that such references be construed as limitations upon the scope of this invention except as set forth in the following claims.

1-15. (canceled)

16. A computer-implemented method for estimating at least one force acting upon a tire mounted on a vehicle, the method comprising:
obtaining at least signals representative of sensed values for tire inflation pressure and/or contained air temperature;
retrieving from data storage one or more tire-specific steady state values, at least one of the one or more tire-specific steady state values corresponding to at least a wear state of the tire;
estimating a rolling resistance force acting upon the tire, based on at least the one or more tire-specific steady state values and the sensed values for tire inflation pressure and/or contained air temperature; and
generating an output signal corresponding to the estimated rolling resistance force acting on the tire.

17. The method of claim 16, wherein the signals representative of sensed values for tire inflation pressure and/or contained air temperature are obtained via at least one sensor mounted to an inner liner of the tire.

18. The method of claim 17, comprising:
estimating a current wear state of the tire in real time based on obtained signals, via the at least one sensor mounted to the inner liner of the tire, corresponding to dynamic mechanical behavior of the tire; and
updating the at least one tire-specific steady-state value corresponding to at least the wear state of the tire based on the estimated current wear state.

19. The method of claim 16, wherein signals representative of sensed values for tire inflation pressure are obtained via a sensor mounted to a valve of the tire.

20. The method of claim 16, wherein signals representative of sensed values for tire inflation pressure are obtained indirectly via a wheel speed sensor external to the tire.

21. The method of claim 16, comprising:
estimating a current wear state of the tire in an event-driven manner based on obtained signals, via at least one external sensor proximate the tire, corresponding to at least a tread depth of the tire; and
updating the at least one tire-specific steady-state value corresponding to at least the wear state of the tire based on the estimated current wear state.

22. The method of claim 16, comprising:
estimating a current wear state of the tire in real time based at least in part on a determined location in which the tire is mounted on the vehicle;
updating the at least one tire-specific steady-state value corresponding to at least the wear state of the tire based on the estimated current wear state.

23. The method of claim 22, comprising estimating the rolling resistance force acting upon the tire based on at least the one or more tire-specific steady state values and/or the sensed values and/or the determined location in which the tire is mounted on the vehicle.

24. The method of claim 16, comprising:
selecting a predictive model relating to energy consumption for the tire and/or the vehicle and/or an operator of the vehicle;
predicting energy consumption values based on at least the output signal corresponding to the estimated rolling resistance force acting on the tire as an input to the selected predictive model; and
generating a display output corresponding to the predicted energy consumption values to an onboard user interface and/or a user interface associated with a fleet management telematics platform.

25. The method of claim 24, wherein the predicted energy consumption values comprise a predicted fuel economy and/or a predicted driving range.

26. The method of claim 25, comprising:
selectively retrieving from data storage historical data relating to driving behavior for the tire and/or the vehicle and/or an operator of the vehicle; and
predicting one or more of the energy consumption values further based on the selectively retrieved historical data as an input to the selected predictive model.

27. The method of claim 26, wherein the predicted one or more of the energy consumption values comprises an estimated fuel savings upon changing to a respective alternative tire and/or an estimated driving range upon changing to the respective alternative tire.

28. The method of claim 26, comprising:
selectively retrieving from data storage tire data relating to a type of the tire mounted on the vehicle and one or more alternative types of tires; and
predicting relative energy consumption values for each of the type of the tire mounted on the vehicle and the one or more alternative types of tires.

29. The method of claim 16, wherein the estimated current tire wear is further utilized as an input to a tire traction detection model, and wherein the estimated current tire wear and/or an estimated tire traction based at least in part on the estimated tire wear is provided as an input to a vehicle control unit.

30. A system for estimating at least one force acting upon a tire mounted on a vehicle, the system comprising:
at least one sensor configured to generate signals representative of values for inflation pressure of the tire and/or contained air temperature of the tire;
data storage having entered and stored thereon one or more tire-specific steady state values, at least one of the one or more tire-specific steady state values corresponding to at least a wear state of the tire; and
a computing device in communication with the at least one sensor and the data storage and further configured to direct the performance of:
estimating a rolling resistance force acting upon the tire, based on at least the one or more tire-specific steady state values and the sensed values for tire inflation pressure and/or contained air temperature; and
generating an output signal corresponding to the estimated rolling resistance force acting on the tire.

31. The system of claim 30, wherein the computing device is further configured to:
estimate a current wear state of the tire:
in real time based on obtained signals corresponding to dynamic mechanical behavior of the tire;
in an event-driven manner based on obtained signals corresponding to at least a tread depth of the tire; and/or
in real time based at least in part on a determined location in which the tire is mounted on the vehicle;
update the at least one tire-specific steady-state value corresponding to at least the wear state of the tire based on the estimated current wear state; and
estimate the rolling resistance force acting upon the tire based on at least the one or more tire-specific steady state values and/or the sensed values and/or the determined location in which the tire is mounted on the vehicle.

32. The system of claim 30, wherein the computing device is further configured to:
select a predictive model relating to energy consumption for the tire and/or the vehicle and/or an operator of the vehicle;
predict energy consumption values based on at least the output signal corresponding to the estimated rolling resistance force acting on the tire as an input to the selected predictive model; and
generate a display output corresponding to the predicted energy consumption values to an onboard user interface and/or a user interface associated with a fleet management telematics platform.

33. An onboard computing device comprising a non-transitory computer readable medium having program instructions residing thereon and executable by a processor to direct the performance of:
obtaining, from at least one sensor associated with a tire mounted on a vehicle, at least signals representative of sensed values for tire inflation pressure and/or contained air temperature;
retrieving from data storage one or more tire-specific steady state values, at least one of the one or more tire-specific steady state values corresponding to at least a wear state of the tire;
estimating a rolling resistance force acting upon the tire, based on at least the one or more tire-specific steady state values and the sensed values for tire inflation pressure and/or contained air temperature; and
generating an output signal corresponding to the estimated rolling resistance force acting on the tire.

34. The onboard computing device of claim 33, wherein the program instructions are further executable to direct the performance of:
estimating a current wear state of the tire:
in real time based on obtained signals corresponding to dynamic mechanical behavior of the tire;
in an event-driven manner based on obtained signals corresponding to at least a tread depth of the tire; and/or
in real time based at least in part on a determined location in which the tire is mounted on the vehicle;
updating the at least one tire-specific steady-state value corresponding to at least the wear state of the tire based on the estimated current wear state; and
estimating the rolling resistance force acting upon the tire based on at least the one or more tire-specific steady state values and/or the sensed values and/or the determined location in which the tire is mounted on the vehicle.

35. The onboard computing device of claim 33, wherein the program instructions are further executable to direct the performance of:
selecting a predictive model relating to energy consumption for the tire and/or the vehicle and/or an operator of the vehicle;
predicting energy consumption values based on at least the output signal corresponding to the estimated rolling resistance force acting on the tire as an input to the selected predictive model; and
generating a display output corresponding to the predicted energy consumption values to an onboard user interface and/or a user interface associated with a fleet management telematics platform.
